(19) United States
(12) Patent Application Publication
(10) Pub. No.: US 2011/0219002 A1
(43) Pub. Date: Sep. 8, 2011

(54) METHOD AND SYSTEM FOR DISCOVERING LARGE CLUSTERS OF FILES THAT SHARE SIMILAR CODE TO DEVELOP GENERIC DETECTIONS OF MALWARE

(75) Inventors: Anthony Vaughan Bartram, Milton Keynes (GB); Adrian M. Dunbar, London (GB)

(73) Assignee: MCAFEE, INC., Santa Clara, CA (US)

(21) Appl. No.: 12/718,683

(22) Filed: Mar. 5, 2010

(51) Int. Cl. G06F 17/30

(52) U.S. Cl. 707/738; 707/E17.046

(57) ABSTRACT

A computer-implemented method for determining similarities between system executable objects includes the steps of determining with one or more computing systems a plurality of subsequences of operation codes in a plurality of disassembled system executable objects, for each subsequence, determining with the one or more computing systems a first set of system executable objects associated with the subsequence, with the computing systems, clustering the first set of system executable objects with a cluster. The cluster includes a set of system executable objects. The step of clustering the first set of system executable objects and the cluster includes the steps of determining with the computing systems the relative similarity between the first set of system executable objects and the cluster, and if the first set of system executable objects is similar to the cluster, adding with the computing systems the system executable objects to the cluster.

### TECHNICAL FIELD OF THE INVENTION

The present invention relates generally to computer security and malware protection and, more particularly, to a method and system to discover large clusters of files that share similar code to develop generic detections of malware.

### BACKGROUND

The operation of electronic devices is affected by the unwanted or malicious effects of third party applications known as malware. Malware may include, but is not limited to, spyware, rootkits, password stealers, spam, sources of phishing attacks, sources of denial-of-service-attacks, viruses, loggers, Trojans, adware, or any other digital content that produces unwanted activity.

Malware affecting electronic devices may avoid detection from anti-malware software by creating different versions and permutations that, while appearing to be different from a binary perspective, essentially comprise the same programs. To determine commonalities among such permutations, signatures of clusters of such similar malware files must be found. Call-graphs can be produced for an executable, and identical sub-graphs identified. However, this requires that the data, which is input for analysis, is structured. The case where it is necessary to find similarities between non-identical operation code sequences requires pair-wise comparisons to compute a distance between each pair because the data representing the sequences is unstructured. Pair-wise comparisons may require significant computing resources. Thus, discovering clusters can take an unreasonably long time when processing thousands of file samples. Such latency can prevent early detection of malware.

### SUMMARY

In one embodiment, a computer-implemented method for determining similarities between system executable objects includes the steps of determining with one or more computing systems a plurality of subsequences of operation codes in a plurality of disassembled system executable objects, for each subsequence, determining with the one or more computing systems a first set of system executable objects associated with the subsequence, with the one or more computing systems, clustering the first set of system executable objects with a cluster. The cluster includes a set of system executable objects. The step of clustering the first set of system executable objects and the cluster includes the steps of determining with the one or more computing systems the relative similarity between the first set of system executable objects and the cluster, and if the first set of system executable objects is similar to the cluster, adding with the one or more computing systems the system executable objects to the cluster.

In another embodiment, an article of manufacture includes a computer readable medium and computer-executable instructions carried on the computer readable medium. The instructions are readable by a processor. The instructions, when read and executed, cause the processor to determine a plurality of subsequences of operation codes in a plurality of disassembled system executable objects, for each subsequence, determine a first set of system executable objects associated with the subsequence, and merge the first set of system executable objects with a cluster. The cluster includes a second set of system executable objects. Causing the processor to merge the first set of system executable objects and the cluster includes further causing the processor to determine the relative similarity between the first set of system executable objects and the cluster, and if the first set of system executable objects is similar to the cluster, add the system executable objects to the cluster.

In yet another embodiment, a system includes a processor, computer readable medium, and computer-executable instructions carried on the computer readable medium. The instructions are readable by the processor. The instructions, when read and executed, cause the processor to determine a plurality of subsequences of operation codes in a plurality of disassembled system executable objects, for each subsequence, determine a first set of system executable objects associated with the subsequence, and merge the first set of system executable objects with a cluster. The cluster includes a second set of system executable objects. Causing the processor to merge the first set of system executable objects and the cluster includes further causing the processor to determine the relative similarity between the first set of system executable objects and the cluster, and if the first set of system executable objects is similar to the cluster, add the system executable objects to the cluster.

### BRIEF DESCRIPTION OF THE DRAWINGS

For a more complete understanding of the present invention and its features and advantages, reference is now made to the following description, taken in conjunction with the accompanying drawings, in which:

FIG. 1 is an illustration of an example system for discovering large clusters of files that share similar code to develop generic detection signatures;

FIG. 2 shows an example embodiment of parsing a file into subsequences of a fixed length of 5;

FIG. 3 is an example embodiment of a method for discovering large clusters of files that share similar code; and

FIG. 4 is an example embodiment of a method for processing a subsequence and its associated files to determine whether the files are sufficiently similar to other files that have been processed.

### DETAILED DESCRIPTION

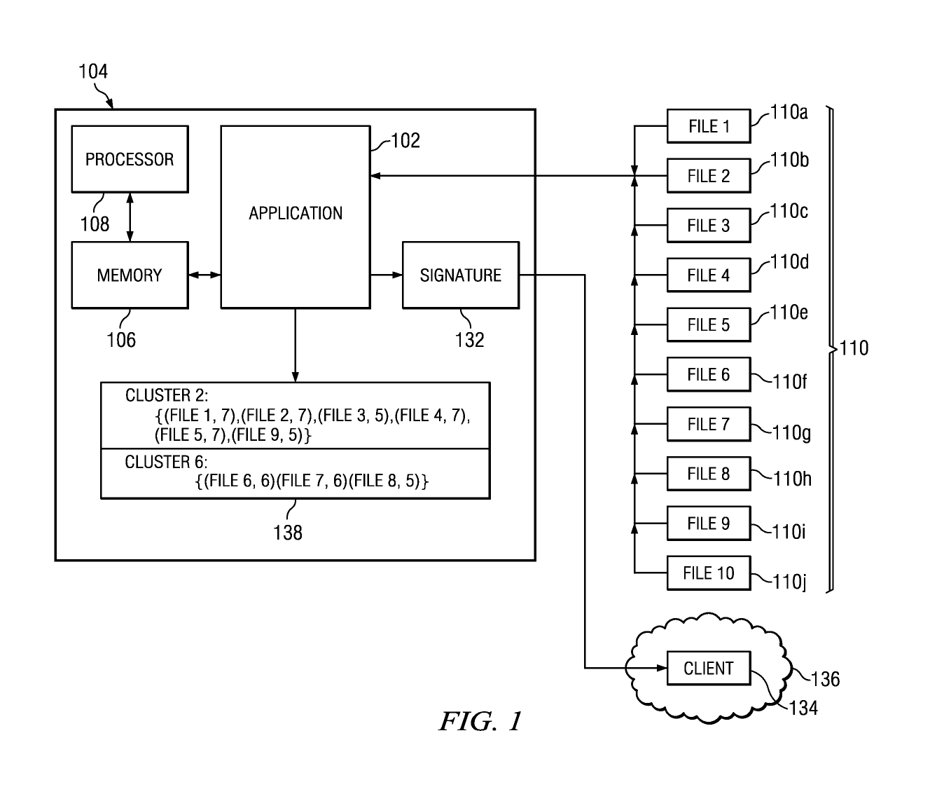

FIG. 1 is an illustration of an example system 100 for discovering large clusters of files that share similar code to develop generic detection signatures. System 100 may comprise an application 102 running on a server 104. Application 102 may be configured to examine multiple files 110 to discover clusters 138 of the files that share similar code, and produce a detection signature 132 for the clusters 138 of files for use by a client 134. The existence of clusters 138 of files 110 may be evidence that the files grouped in clusters 138 may comprise malware.

Server 104 may comprise a processor 108 coupled to a memory 106. Processor 108 may comprise, for example a microprocessor, microcontroller, digital signal processor (DSP), application specific integrated circuit (ASIC), or any other digital or analog circuitry configured to interpret and/or execute program instructions and/or process data. In some embodiments, processor 108 may interpret and/or execute program instructions and/or process data stored in memory 106. Memory 106 may be configured in part or whole as application memory, system memory, or both. Memory 106 may include any system, device, or apparatus configured to hold and/or house one or more memory modules. Each memory module may include any system, device or apparatus configured to retain program instructions and/or data for a period of time (e.g., computer-readable media).

Application 102 may reside on server 104, or on any other electronic device, server, or other suitable mechanism. Application 102 may comprise a application, process, script, module, executable, server, executable object, library, or other suitable digital entity. Application 102 may be configured to reside in memory 106 for execution by processor 108 with instructions contained in memory 106. Server 104 or application 102 may be communicatively coupled to a client 134 through network 136, or any other suitable network or communication scheme. Network 136 may comprise any suitable network for communication between client 134 and application 102 or server 104. Such a network may include but is limited to: the Internet, an intranet, wide-area-networks, local-area-networks, back-haul-networks, peer-to-peer-networks, or any combination thereof. In one embodiment, application 102 may be configured to operate in a cloud computing scheme.

Files 110 may comprise system executable objects, including but not limited to executables, scripts, object code, shared libraries, or modules. Files 110 may comprise system executable objects collected from scripts, scrapers, machines running anti-virus software, or any other suitable source. Files 110 may comprise system executable objects whose status as either malware or safe objects is unknown. Files 110 may reside on electronic device 104, in memory 106, or in any suitable place suitably accessible by application 102. Files 110 may be disassembled into the assembly code operations comprising the file. Files 110 may comprise assembly code operations ordered into the order in which they would appear in the system executable object. Files 110 comprising ordered assembly code operations may have addresses or other parameters removed.

TABLE 1 is an example embodiment of the contents of files 110 after the files have been disassembled.

TABLE 1

| | |
|---|---|
| File 1 = | A B C D E F A B A B G G G G |
| File 2 = | C B C D E F A B A B G H G G |
| File 3 = | B A C D E F A B A B G G G H |
| File 4 = | A B C D E F A B A B G G G G |
| File 5 = | A B C D E F A B A B G G G G |
| File 6 = | G A B C D A A F E F E |
| File 7 = | G A B C D A A F E F E |
| File 8 = | G B B C D A A F E F E |
| File 9 = | B A A D E F A B A B G G G H |
| File 10 = | F F F A B C A |

TABLE 1 illustrates, for each file, a sequence of operational codes that comprise part of a system executable object. A, B, C, D, E, F, G, and H may represent possible different operational codes that may be found in the system executable objects comprising files 110. The order of the operational codes in each system executable object may follow a particular sequence, which may be reflected by the left to right order of the operational code representations in the object's entry in TABLE 1.

Application 102 may be configured to examine one or more files 110 to discover which, if any, of files 110 are essentially the same. Files 110 may comprise malware, viruses, Trojans, Rootkits or other malicious system executable objects. Files 110 may comprise permutations of a single instance of malware that have been manipulated to appear different from one another, though the different permutations may maliciously act the same way. Permutations of files 110 comprising malware may have been created to avoid detection through traditional anti-malware mechanisms.

Application 102 may be configured to determine approximately how similar files 110 are to one another. Application 102 may be configured to determine clusters 138 of files 110 whose machine executable code similarities are sufficiently similar to be determined as essentially the same file. Clusters 138 may comprise any grouping of files 110 whose code similarities are sufficiently similar to be deemed to be essentially the same file. In one embodiment, clusters 138 may be implemented by a data structure. Clusters 138 may reside in memory 106.

Application 102 may be configured to generate a signature 132 by which a file may be identified as a member of a particular cluster 138 of files. Signature 132 may be configured to identify a given file as belonging to a particular cluster 138 of files. Signature 132 may comprise a file signature, hash, or any suitable mechanism to identify whether a file belongs to a particular cluster 138 of files. Application 102 may be configured to communicate signature 132 to client 134. In one embodiment, application 102 may be configured to communicate signature 132 to client 134 over network 136. Signature 132 may be configured to be deployed to client 134 through any suitable technique or mechanism.

Client 134 may comprise an electronic device. Client 134 may be configured to scan elements of client 134, or elements encountered by client 134 for malware. Client 134 may comprise anti-malware software, libraries, shared libraries, modules, or other electronic techniques for scanning for malware. In one embodiment, client 134 may be configured to apply such techniques with file signatures of system executable objects known to comprise malware. In one embodiment, client 134 may compare such a file signature against an encountered system executable object, whose status as malware is unknown. Client 134 may be configured to take appropriate action upon the detection of malware, including blocking access to the malware or cleaning the electronic device of malware.

In operation, the files 110 may be disassembled into sequences of operational codes as shown in TABLE 1. For each of files 110, the file's operational code sequence is parsed into subsequences. In one embodiment, the operational code sequence is parsed into subsequences of a fixed length. Any unique subsequence of operational codes in the file is thus determined.

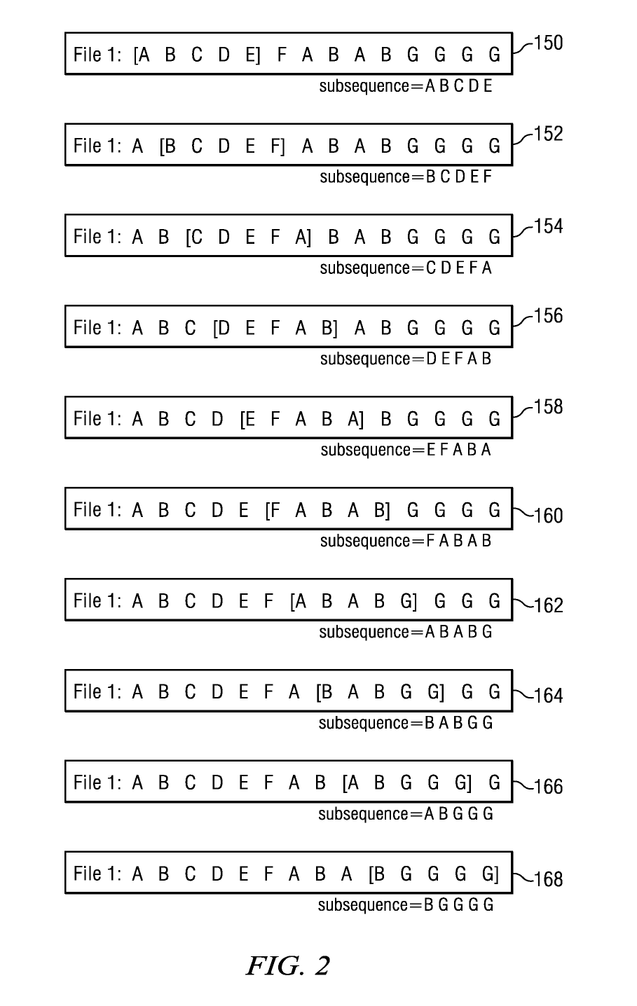

FIG. 2 shows an example embodiment of this operation for File1 110a, where the operational code sequence of File1 110a is parsed into subsequences of a fixed length of 5. File1 110a may comprise the sequence: {A B C D E F A B A B G G G G}. In step 150, file 110a may be parsed with a fixed subsequence length of five to determine the first five operational codes of the sequence, yielding the subsequence [A B C D E]. In step 152, file 110a may be parsed again, with the parsing window moving to the right one element in the sequence, yielding the subsequence [B C D E F]. The process of moving through the sequence with a window one element at a time, and parsing out a subsequence of a fixed length may be repeated in steps 154-168. Thus, File1 110a may be determined as containing the operational code subsequences: [A B C D E], [B C D E F], [C D E F A], [D E F A B], [E F A B A], [F A B A B], [A B A B G], [B A B G G], [A B G G G], and [B G G G G]. The process of determining the subsequences contained within a file may be repeated for each of files 110.

Returning to FIG. 1, after the subsequences present within files 110 have been determined, the subsequences may be cross-referenced so that it may be determined which files contain the same subsequence. For example, after determining the subsequences contained within files 110, the subsequences may be associated with one or more files as demonstrated in TABLE 2:

TABLE 2

| Subsequence | Files |
|---|---|
| ABCDE | 145 |
| BCDEF | 1245 |
| CDEFA | 12345 |
| DEFAB | 123459 |
| EFABA | 123459 |
| FABAB | 123459 |
| ABABG | 123459 |
| BABGG | 13459 |
| ABGGG | 13459 |
| BGGGG | 145 |
| CBCDE | 2 |
| BABGH | 2 |
| ABGHG | 2 |
| BGHGG | 2 |
| BACDE | 3 |
| BGGGH | 39 |
| GABCD | 67 |
| ABCDA | 67 |
| BCDAA | 678 |
| CDAAF | 678 |
| DAAFE | 678 |
| AAFEF | 678 |
| AFEFE | 678 |
| BAADE | 9 |
| AADEF | 9 |
| ADEFA | 9 |
| FFFAB | 10 |
| FFABC | 10 |
| FABCA | 10 |

As illustrated in TABLE 2, some subsequences may appear in multiple files, such as [D E F A B], and some subsequences may appear in a single file, such as [C B C D E].

Application 102 may then process the subsequences and their associated set of files into clusters, wherein the clusters represent sets of files that are functionally similar based on the similarities of subsequences between the different files. Any suitable method may be used to determine whether different files are sufficiently functionally similar. In one embodiment, as explained in further detail below, Jaccardian distance between a set of files containing a particular subsequence and existing clusters may be used to determine whether the set of files is sufficiently functionally similar to an existing cluster of files.

Application 102 may create a cluster from a first subsequence to be processed. The cluster may comprise the identities of the files associated with the subsequence. For example, the first subsequence from TABLE 2 is [A B C D E], which may be associated with File1 110a, File4 110d, and File5 110e. Thus, a cluster may be created, noting the files associated with each other by way of the common subsequence. The cluster may also comprise an identification of how many times a given file has been associated with the cluster. For example, a cluster for the first subsequence from TABLE 2 may be created as:
Cluster 1: {(File1, 1) (File4, 1) (File5, 1)}
   because File1, File4, and File5 have been associated with the cluster one time each. Thus, a cluster may comprise a key-value pair, the key-value pair comprising an identifier of the file and a count.

Application 102 may subsequently compare the files associated with another subsequence to the different clusters. If a given subsequence's associated set of files are sufficiently similar to a given cluster, the subsequence and its associated set of files are assigned to the cluster. If a given subsequence's associated set of files are not sufficiently similar to any existing cluster, a new cluster comprising the subsequence's associated set of files may be created.

To determine whether a given subsequence's associated set of files belong to a given cluster, application 102 may calculate the Jaccardian distance between the set of files associated with the subsequence, and the elements of the cluster. If the Jaccardian distance is sufficiently small, then the cluster and the subsequence's associated set of files are sufficiently similar to determine that the set of files containing the subsequence and the cluster are functionally equivalent, in terms of the operational codes of the associated subsequences. If the Jaccardian distance is not sufficiently small, then the cluster and the subsequence's associated set of files are not sufficiently similar, and the subsequence's associated set of files may be compared to a subsequent cluster.

In one embodiment, the Jaccardian distance between the set of files 110 and a cluster may be calculated by calculating the Jaccardian distance between the cluster and the set of files associated with a subsequence. The Jaccardian distance is the difference between the union and intersection of two sets, divided by the union. In one embodiment, the Jaccardian distance between two sets A and B can be calculated as:

$${J}_{distance} = \frac{\vert A ⋃ B \vert - \vert A ⋂ B \vert}{\vert A ⋃ B \vert}$$

In one embodiment, A may be the set of files that are associated with a given cluster, and B may be the set of files associated with the operational codes for a given subsequence. For example, the Jaccardian distance between Cluster 1, as shown above, and a second subsequence to be processed, such as [B C D E F] with associated files File1 110a, File4 110d, and File5 110e, may be given as:

$${J}_{distance} = \frac{\begin{matrix}\vert \{ File 1 , File 4 , File 5 \} ⋃ \{ File 1 , File 4 , File 5 \} \vert - \\ \vert \{ File 1 , File 4 , File 5 \} ⋂ \{ File 1 , File 4 , File 5 \} \vert\end{matrix}}{\vert \{ File 1 , File 4 , File 5 \} ⋃ \{ File 1 , File 4 , File 5 \} \vert}$$

$$\begin{matrix}{J}_{distance} = \frac{\vert \{ File 1 , File 4 , File 5 \} \} \vert - \vert \{ File 1 , File 4 , File 5 \} \vert}{\vert \{ File 1 , File 4 , File 5 \} \vert} \\ = \frac{3 - 3}{3} \\ = 0\end{matrix}$$

Thus the Jaccardian distance between the files associated with the subsequence [B C D E F] and Cluster 1 may be 0. This corresponds with the fact that the elements in the two sets are identical.

Application 102 may use the Jaccardian distance between the set of files associated with the subsequence and a given cluster to determine whether the set of files is sufficiently similar to the cluster. In one embodiment, application 102 may use a threshold, below which a Jaccardian distance may indicate that a set of files and a cluster are sufficiently similar. In a further embodiment, application 102 may use a threshold for Jaccardian distance of 0.2. In yet another embodiment, application 102 may compare the calculated Jaccardian distance against a previously determined Jaccardian distance for the same subsequence against a different cluster. In such an embodiment, application 102 may determine that the set of files is sufficiently similar to the cluster with the shortest Jaccardian distance from the set of files. In such an embodiment, application 102 may disregard Jaccardian distances from other clusters with longer Jaccardian distances from the set of files, even though the other Jaccardian distances are less than the threshold.

If application 102 determines that the cluster of files and the subsequence's associated set of files are sufficiently related, the subsequence's associated set of files may be associated with the cluster. The elements of the cluster may be updated to include the incidence of the files associated with the subsequence. For example, Cluster 1 may now comprise:
Cluster 1: {(File1, 2) (File4, 2) (File5, 2)}
   wherein the counts associated with File1, File4, and File5 have been incremented according to their association with the subsequence [B C D E F]. Application 102 may also record the Jaccardian distance between the set of files and the cluster for comparison in further iterations.

If application 102 determines that the cluster of files and the subsequence's associated set of files are not sufficiently related, the comparison of the subsequence's associated set of files may be repeated for a different cluster. However, if the subsequence's associated set of files are not sufficiently similar to any cluster, a new cluster may be created for the files associated with the subsequence. For example, application 102 may process another subsequence, [C D E F A] and its associated files File1 110a, File2 110b, File3 110c, File4 110d, and File5 110e. The Jaccardian distance between the files associated with subsequence [C D E F A] and Cluster 1 may be calculated as:

$$\begin{matrix}{J}_{distance} = \frac{\vert \{ 1 , 4 , 5 \} ⋃ \{ 1 , 2 , 3 , 4 , 5 \} \vert - \vert \{ 1 , 4 , 5 \} ⋂ \{ 1 , 2 , 3 , 4 , 5 \} \vert}{\vert \{ \{ 1 , 4 , 5 \} ⋃ \{ 1 , 2 , 3 , 4 , 5 \} \} \vert} \\ = \frac{\vert \{ 1 , 2 , 3 , 4 , 5 \} \vert - \vert \{ 1 , 4 , 5 \} \vert}{\vert \{ 1 , 2 , 3 , 4 , 5 \} \vert} \\ = \frac{5 - 3}{5} \\ = 0.4\end{matrix}$$

(“File” denotations omitted for space). Application 102, applying a Jaccardian distance threshold of 0.2, may determine that Cluster 1 and the files associated with subsequence [C D E F A] are not sufficiently similar, and subsequently create a new cluster for the files associated with subsequence [C D E F A]. The new cluster may be updated with counts associated with each file in the cluster. Thus, after processing the first three subsequences, Application 102 may determine that there are two clusters of files:

Cluster 1: {(File1, 2) (File4, 2) (File5, 2)}

Cluster 2: {(File1, 1) (File2, 1) (File3, 1) (File4, 1) (File5, 1)}

Application 102 may continue to process the subsequences to determine the similarity of the subsequences' associated set of files to clusters of files. If a file associated with more than one subsequence is found to be sufficiently similar to more than one cluster of files, then application 102 may associate the file with the cluster of files for which the similarity is the greatest. In one embodiment, application 102 may associate the file with the cluster having the smallest Jaccardian distance between the file and the cluster.

While application 102 is processing the subsequences, periodically application 102 may resolve clusters and eliminate noise from the cluster sets. Application 102 may resolve clusters and eliminate noise at a fixed pruning interval based on the number of subsequences or clusters that have been processed. Any suitable interval may be selected, based upon the size of the data from files 110 to be processed.

Application 102 may remove noise from a given cluster. Noise in a given cluster may comprise files that are statistically weakly associated with the cluster. Any suitable criteria for which files are statistically weak may be selected according to the specific data of files 110. In one embodiment, a mean of all the values from the key-value pairs in a cluster may be calculated, where key-value pairs comprise a key in the form of an identifier for a file which may comprise a number, and a value that may comprise a count of the number of instances of that file. If any values in the cluster vary from the mean by a specified noise ratio percentage, then the associated key-value pairs may be removed from the cluster. In one such embodiment, a specified noise ration percentage of 95% may be chosen.

Application 102 may resolve different clusters of files such that a file may appear in a single cluster. For a first file to be sufficiently similar to second file, it may be expected that the first file could not also be sufficiently similar to a third file, unless the third file is also sufficiently similar to the second file. In addition, some duplication in the clusters may occur. Thus, application 102 may resolve clusters of files such that a file may appear only once, and in the cluster for which it is most strongly similar. In one embodiment, application 102, for each file in the set of clusters, may determine which cluster comprises the highest value for the file, representing the number of times the file has been associated with the cluster. Application 102 may then delete all other key-value pair instances for the file from other clusters, which are not the highest value for the file.

For example, after processing some of the subsequences from TABLE 1, application 102 may have yielded two clusters:

Cluster 1: {(File1, 3), (File4, 3), (File5, 3)}

Cluster 2: {(File1, 7), (File2, 7), (File3, 5), (File4, 7), (File5, 7), (File9, 5)}

The key-value pairs in Cluster 1 are duplicative of the key-value pairs in Cluster 2. Thus, application 102 may remove the key-value pairs with the lower values. In this example, File1, File4, and File 5 in Cluster 1 are all duplicates of entries in Cluster 2, but with smaller counts. Thus, these may be removed from Cluster 1. After such an action, application 102 may try to match future instances of File1, File4, and File5 in subsequences to Cluster 2, but not to Cluster 1.

After processing the subsequences from files 110, application 102 may determine that some clusters comprise outliers and do not represent files that should be considered statistically similar to each other. For example, after processing the subsequences of TABLE 1, application 102 may have found three clusters:

Cluster 2: {(File1, 7) (File2, 7) (File3, 5) (File4, 7) (File5, 7) (File9, 5)}

Cluster 6: {(File6, 6) (File7, 6) (File8, 5)}

Cluster 10: {(File10, 3)}

Cluster 10 consists of a single file, and thus application 102 may discard Cluster 10.

Once the subsequences from file 100 have been processed, the resulting clusters 138 may indicate files 110 that are substantially similar to each other. Such an association may be an indication of malware. The files in the cluster may have been transformed to avoid detection by traditional anti-virus mechanisms. If one of the files in these clusters comprises known malware, then the other files in the cluster may be considered to be the same kind of malware, even though the other files may not have been previously shown an indication of malware.

Application 102 may use discovery of clusters 138 of files to protect electronic devices from malware infection associated with the files in the discovered clusters. Via a network, application 102 may inform anti-virus databases, monitors, or other systems of the existence of the clusters of files. Application 102 may also generate a signature 132 for the clusters that may be used to identify files that are members of a given cluster.

For a given cluster that has been discovered, the operational code subsequences common to the files in the cluster may be extracted. A subset of these subsequences may be deployed as a detection signature 132. Application 102 may compare the subset against operational code sequences that are present in known safe files, to avoid generating a signature 132 that is a false positive. In one embodiment, application 102 may exclude operational code sequences known to be safe. Application 102 may also determine whether subsequences form a long distinct subsequence, and generate a detection signature 132 based upon the longer sequence. For example, three sequences common to files in a cluster may be:

Sequence 1: {A, B, C, D, E, F}

Sequence 2: {B, C, D, E, F, G}

Sequence 3: {C, D, E, F, G, H}

Therefore, application 102 may create a signature 132 for the sequence of operational codes {A, B, C, D, E, F, G, H}.

Application may send, communicate, or otherwise deploy signature 132 to a client 134 over a network 136. Client 134 may apply the signature alone or as part of a larger anti-malware scheme designed to protect client 134 or another electronic device from malware. Client 134 may utilize a search algorithm such as a Boyer-Moore algorithm to find the machine instruction sequences in a program that is being examined for malware. If all of the machine instruction sequences from the signature 132 are present in the program that is being examined, then malware in the program may be detected.

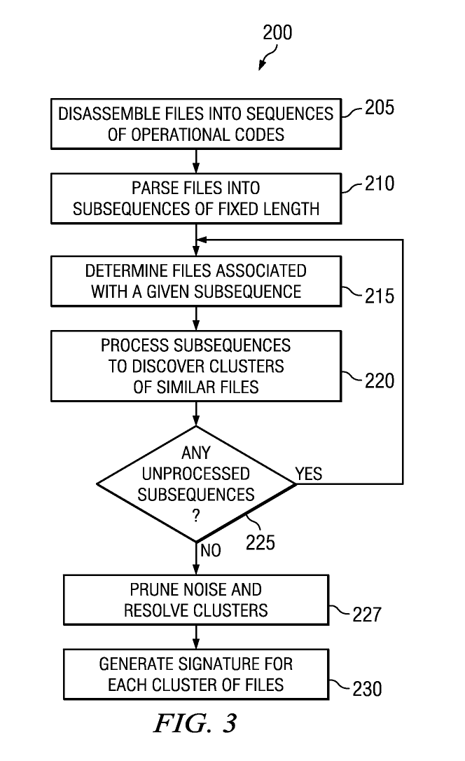

FIG. 3 is an example embodiment of a method 200 for discovering large clusters of files that share similar code. In step 205, a number of files that are to be analyzed may be disassembled into sequences of operational code. In step 210, the disassembled files may be parsed into subsequences. In one embodiment, the subsequences may be of a fixed length. In step 215, all the files which contain a given subsequence may be determined. In step 220, the subsequence and its associated set of files may be processed to determine whether the files are sufficiently similar to other files that have been processed. The result may be the discovery of clusters of files that share similar code. In step 225, if all subsequences have been processed, the method may proceed to step 227. If any subsequences remain unprocessed, steps 215-220 may be repeated for another subsequence found within the files to be analyzed. In step 227, cluster noise may be removed. In addition, clusters may be resolved. In step 230, a signature corresponding to each discovered cluster of files may be generated. The signature may be transmitted to a client or other mechanism for monitoring an electronic device for malware. The signature may be used to determine whether a given file encountered by the electronic device comprises malware.

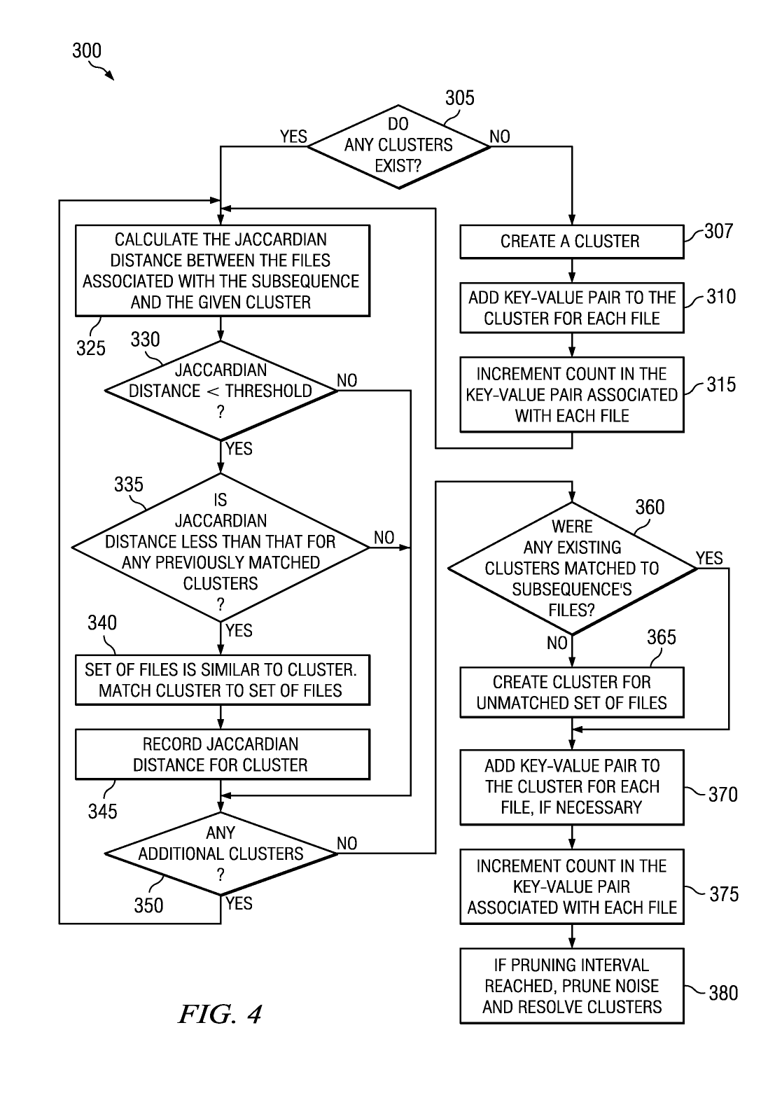

FIG. 4 is an example embodiment of a method 300 for processing a subsequence and its associated set of files to determine whether the files are sufficiently similar to other files that have been processed. Method 300 may be an embodiment for accomplishing step 220.

In step 305, it may be determine whether any clusters of files exist to compare against the files of a subsequence. If a cluster already exists, method 300 may proceed to step 325. If no clusters exist, a cluster may be created in step 307. In step 310, a key-value pair, comprising an identifier for a file and a count associated with the file, may be added to the cluster for each file associated with the subsequence. In step 315, the count associated with the key-value pairs may be incremented.

In steps 325-345, for a given subsequence, it may be determined whether the files associated with the subsequence are sufficiently similar to a given cluster. In step 325, the similarity between the set of files associated with the subsequence and the given cluster may be determined. In one embodiment, the Jaccardian distance between the set of files and the given cluster may be calculated. In step 330, the Jaccardian distance may be evaluated. If the Jaccardian distance is greater than the threshold, then method 300 may proceed to step 350. If the Jaccardian distance is less than the threshold, then in step 335, the Jaccardian distance may be compared against the Jaccardian distance found in any other clusters previously matched to the given subsequence. If the Jaccardian distance is greater than that in clusters previously matched to the given subsequence, then method 300 may proceed to step 350. If the Jaccardian distance is less than that in any clusters previously matched to the given subsequence, or no clusters were previously matched, then in step 340 it may be determined that the given cluster is sufficiently similar to the set of files associated with the given subsequence. The cluster may be matched to the set of files. A previously matched cluster may be disregarded. In step 345, the Jaccardian distance between the cluster and the set of files may be recorded for future comparisons such as that of Step 335.

In step 350, it may determined whether additional clusters of files exist which may be compared against the files of the given subsequence. If any additional clusters of files exist, step 325 may be repeated for another cluster and the given subsequence. If no additional clusters of files exist, in step 360, if no existing clusters were matched to the files associated with the given subsequence, then in step 365 a cluster may be created for the unmatched set of files. Otherwise, in step 370, a key-value pair may be added to the matched or created cluster for each file associated with the subsequence, if necessary. In step 375, the count associated with the key-value pairs in the matched or created cluster may be incremented.

In step 380, if a pruning interval has been reached, then cluster noise may be removed. In addition, clusters may be resolved.

Methods 200 and 300 may be implemented using the system of FIG. 1, or any other system operable to implement methods 200 and 300. As such, the preferred initialization point for methods 200 and 300 and the order of the steps comprising methods 200 and 300 may depend on the implementation chosen. In some embodiments, some steps may be optionally omitted, repeated, or combined. In some embodiments, some steps of method 200 may be accomplished in method 300, and vice-versa. In some embodiments, methods 200 and 300 may be combined. In certain embodiments, methods 200 and 300 may be implemented partially or fully in software embodied in computer-readable media.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other electromagnetic and/or optical carriers; and/or any combination of the foregoing.

Although the present disclosure has been described in detail, it should be understood that various changes, substitutions, and alterations can be made hereto without departing from the spirit and the scope of the disclosure as defined by the appended claims.

What is claimed is:

1. A computer-implemented method for determining similarities between system executable objects, comprising the steps of:
determining with one or more computing systems a plurality of subsequences of operation codes in a plurality of disassembled system executable objects;
for each subsequence, determining with the one or more computing systems a first set of system executable objects associated with the subsequence; and
with the one or more computing systems, clustering the first set of system executable objects with a cluster, the cluster comprising a second set of system executable objects, wherein
clustering the first set of system executable objects and the cluster comprises the steps of:
determining with the one or more computing systems the relative similarity between the first set of system executable objects and the cluster; and
if the first set of system executable objects is similar to the cluster, adding with the one or more computing systems the system executable objects to the cluster.

2. The method of claim 1, wherein the step of determining the relative similarity between the first set of system executable objects and the cluster further comprises calculating with the one or more computing systems a Jaccardian distance between the first set of system executable objects and the cluster.

3. The method of claim 1, wherein the step of determining the relative similarity between the first set of system executable objects and the cluster further comprises:
with the one or more computing systems, comparing a Jaccardian distance between the first set of system executable objects and the cluster against a threshold; and
if the Jaccardian distance is less than the threshold, determining with the one or more computing systems that the first set of system executable objects and the cluster are similar.

4. The method of claim 1, wherein the step of clustering the first set of system executable objects with a cluster comprises the step of creating with the one or more computing systems the cluster, the cluster comprising the first set of system executable objects, wherein:
the relative similarity between the first set of system executable objects and one or more other clusters was determined; and
the first set of system executable objects was not similar to any of the one or more other clusters.

5. The method of claim 1, further comprising the step of disassembling with the one or more computing systems a plurality of system executable objects into a sequence of operational codes.

6. The method of claim 1, wherein:
the cluster comprises a count associated with each of the system executable objects in the cluster; and
the step of adding the first set of system executable objects to the cluster further comprises increasing with the one or more computing systems the count associated with each member of the first set of system executable objects that are in the cluster.

7. The method of claim 6, further comprising the step of removing with the one or more computing systems a first cluster, wherein:
the first cluster comprises a system executable object;
the system executable object is present in the first cluster and in a second cluster; and
the count associated with the system executable object in the first cluster is less than the count associated with the system executable object in the second cluster.

8. The method of claim 6, further comprising the step of, with the one or more computing systems, eliminating a cluster, the cluster comprising a system executable object with a statistically insignificant count.

9. The method of claim 6, further comprising the step of eliminating a first cluster, wherein:
the first cluster comprises a plurality of system executable objects present in a second cluster; and
the relative similarity between the plurality of system executable objects and the first cluster is less than the relative similarity between the plurality of system executable objects and the second cluster.

10. The method of claim 1, further comprising the step of generating with the one or more computing systems a generic signature for the files of the cluster.

11. An article of manufacture, comprising:
a computer readable medium; and
computer-executable instructions carried on the computer readable medium, the instructions readable by a processor, the instructions, when read and executed, for causing the processor to:
determine a plurality of subsequences of operation codes in a plurality of disassembled system executable objects;
for each subsequence, determine a first set of system executable objects associated with the subsequence; and
merge the first set of system executable objects with a cluster, the cluster comprising a second set of system executable objects, wherein:
causing the processor to merge the first set of system executable objects and the cluster comprises further causing the processor to:
determine the relative similarity between the first set of system executable objects and the cluster; and
if the first set of system executable objects is similar to the cluster, add the system executable objects to the cluster.

12. The article of claim 11, wherein causing the processor to determine the relative similarity between the first set of system executable objects and the cluster further comprises causing the processor to calculate a Jaccardian distance between the first set of system executable objects and the cluster.

13. The article of claim 11, wherein the causing the processor to determine the relative similarity between the first set of system executable objects and the cluster further comprises causing the processor to:
compare a Jaccardian distance between the first set of system executable objects and the cluster against a threshold;
if the Jaccardian distance is less than the threshold, determine that the first set of system executable objects and the cluster are similar.

14. The article of claim 11, wherein causing the processor to merge the first set of system executable objects with a cluster of sets of system executable objects further comprises causing the processor to create the cluster of sets of system executable objects, the cluster comprising the first set of system executable objects, wherein:
the relative similarity between the first set of system executable objects and one or more other clusters was determined; and
the first set of system executable objects was not similar to any of the one or more other clusters.

15. The article of claim 11, wherein the processor is further caused to disassemble a plurality of system executable objects into a sequence of operational codes.

16. The article of claim 11, wherein:
the cluster comprises a count associated with each of the system executable objects in the cluster; and
causing the processor to add the first set of system executable objects to the cluster further comprises causing the processor to increase the count associated with each of the system executable objects in the cluster.

17. The article of claim 16, wherein the processor is further caused to remove a first cluster, wherein:
the first cluster comprises a system executable object;
the system executable object is present in the first cluster and in a second cluster;
the count associated with the system executable object in the first cluster is less than the count associated with the system executable object in the second cluster.

18. The article of claim 16, wherein the processor is further caused to eliminate a cluster, the cluster comprising a system executable object with a statistically insignificant count.

19. The article of claim 16, wherein the processor is further caused to eliminate a first cluster, wherein:
the first cluster comprises a plurality of system executable objects present in a second cluster;
the relative similarity between the plurality of system executable objects and the first cluster is less than the relative similarity between the plurality of system executable objects and the second cluster.

20. The article of claim 11, wherein the processor is further caused to generate a generic signature for the files of the cluster.

21. A system comprising:
a processor;
a computer readable medium; and
computer-executable instructions carried on the computer readable medium, the instructions readable by the processor, the instructions, when read and executed, for causing the processor to:
determine a plurality of subsequences of operation codes in a plurality of disassembled system executable objects;
for each subsequence, determine a first set of system executable objects associated with the subsequence; and
merge the first set of system executable objects with a cluster, the cluster comprising a second set of system executable objects, wherein:
causing the processor to merge the first set of system executable objects and the cluster comprises further causing the processor to:
determine the relative similarity between the first set of system executable objects and the cluster; and
if the first set of system executable objects is similar to the cluster, add the system executable objects to the cluster.

22. The system of claim 21, wherein causing the processor to determine the relative similarity between the first set of system executable objects and the cluster further comprises causing the processor to calculate a Jaccardian distance between the first set of system executable objects and the cluster.

23. The system of claim 21, wherein the causing the processor to determine the relative similarity between the first set of system executable objects and the cluster further comprises causing the processor to:
compare a Jaccardian distance between the first set of system executable objects and the cluster against a threshold;
if the Jaccardian distance is less than the threshold, determine that the first set of system executable objects and the cluster are similar.

24. The system of claim 21, wherein causing the processor to merge the first set of system executable objects with a cluster of sets of system executable objects further comprises causing the processor to create the cluster of sets of system executable objects, the cluster comprising the first set of system executable objects, wherein:
the relative similarity between the first set of system executable objects and one or more other clusters was determined; and
the first set of system executable objects was not similar to any of the one or more other clusters.

25. The system of claim 21, wherein the processor is further caused to disassemble a plurality of system executable objects into a sequence of operational codes.

26. The system of claim 21, wherein:
the cluster comprises a count associated with each of the system executable objects in the cluster; and
causing the processor to add the first set of system executable objects to the cluster further comprises causing the processor to increase the count associated with each of the system executable objects in the cluster.

27. The system of claim 26, wherein the processor is further caused to remove a first cluster, wherein:
the first cluster comprises a system executable object;
the system executable object is present in the first cluster and in a second cluster;
the count associated with the system executable object in the first cluster is less than the count associated with the system executable object in the second cluster.

28. The article of claim 26, wherein the processor is further caused to eliminate a cluster, the cluster comprising a system executable object with a statistically insignificant count.

29. The system of claim 26, wherein the processor is further caused to eliminate a first cluster, wherein:
the first cluster comprises a plurality of system executable objects present in a second cluster;
the relative similarity between the plurality of system executable objects and the first cluster is less than the relative similarity between the plurality of system executable objects and the second cluster.

30. The system of claim 21, wherein the processor is further caused to generate a generic signature for the files of the cluster.
